(19) United States
(12) Patent Application Publication
(10) Pub. No.: US 2007/0299581 A1
(43) Pub. Date: Dec. 27, 2007

(54) Limiting Motor-Vehicle Rollback

(76) Inventors: Antonio Mallol Torralbo, Valencia (ES); Michael Bachmann, Weissach (DE)

Correspondence Address: KENYON & KENYON LLP, ONE BROADWAY, NEW YORK, NY, 10004, US

(21) Appl. No.: 11/630,090

(22) PCT Filed: May 10, 2005
(86) PCT No.: PCT/EP05/52094

§ 371 Date: Jun. 8, 2007

(30) Foreign Application Priority Data
Jun. 25, 2004 (DE) 10 2004 030 795.4

(51) Int. Cl. G05D 3/12

(52) U.S. Cl. 701/41

(57) ABSTRACT

A method for limiting motor-vehicle rollback includes steps in which: the drive direction of the vehicle belonging to the engaged gear step, i.e., transmission step, is determined; the direction of movement of the vehicle is determined; and in the case when the direction of movement is opposite the drive direction, a braking intervention is implemented independently of the driver at the wheels of at least one axle.

### FIELD OF THE INVENTION

The present invention relates to a method for limiting motor-vehicle rollback.

### BACKGROUND INFORMATION

Published German patent document DE 199 25 368 describes a method and a device for controlling a vehicle, in which cruise control is implemented only when downhill travel is detected. Downhill travel detection operates on the basis of the actual acceleration of the vehicle and a calculated model acceleration of the vehicle, such that downhill travel is detected when the change in actual acceleration and the deviation between the actual acceleration and the model acceleration are positive.

### summary

The present invention provides a method for limiting motor-vehicle rollback, in which
the drive direction of the vehicle belonging to the engaged gear step or transmission step is determined,
the direction of movement of the vehicle is determined and
for the case when the direction of movement is opposite the drive direction, a braking intervention is performed independently of the driver at the wheels of at least one axle.
   It is thus possible to limit the extent of vehicle movements not intended by the driver, via braking interventions.

An advantageous example embodiment of the present invention provides that the braking intervention is performed so that the absolute value of the vehicle speed does not exceed a predetermined longitudinal vehicle speed in the direction of movement, this longitudinal speed being different from zero.

An advantageous example embodiment of the present invention provides that the braking intervention is performed so that the absolute value of the vehicle speed is regulated to the preselected longitudinal vehicle speed.

An advantageous example embodiment of the present invention provides that a constant longitudinal vehicle speed is set as part of an HDC regulation. This makes it possible to use an HDC functionality (HDC=hill descent control) that is possibly already provided in the vehicle.

An advantageous example embodiment of the present invention provides that the method is performed as a function of the position of the accelerator pedal.

An advantageous example embodiment of the present invention provides that the method is implemented when the accelerator pedal is operated. It is also possible for the method to be performed only when the accelerator pedal is operated.

The latter two example embodiments ensure that the method is implemented only when there is an intent to drive on the part of the driver.

An advantageous example embodiment of the present invention provides that the method is implemented as a function of the position of the clutch pedal. It is also possible for the method to be implemented only when the clutch pedal is operated.

An advantageous example embodiment of the present invention provides that the method is implemented when the clutch pedal is fully or partially operated.

In a case when the clutch pedal is not operated, movement of the vehicle in the direction opposite the direction of the gear results in stalling of the engine.

In addition, the present invention provides a device for limiting motor-vehicle rollback, including
drive direction determination means for determining the drive direction belonging to the engaged gear step, i.e., the transmission step,
movement direction determination means for determining the direction of movement of the vehicle,
comparison means for comparing the drive direction and the direction of movement, and
brake means by which a braking intervention is implemented independently of the driver on the wheels of at least one axle in the case when the direction of movement is opposite the intended drive direction.

An advantageous example embodiment of the present invention provides that the movement direction determination means are wheel rpm sensors.

### BRIEF DESCRIPTION OF THE DRAWINGS

FIG. 1 shows the curves of various vehicle parameters as a function of time.

FIG. 2 shows a flowchart illustrating an example method according to the present invention.

FIG. 3 shows a block diagram illustrating an example embodiment of the device according to the present invention.

### DETAILED DESCRIPTION

On a steep slope and/or a longitudinal inclination in the road surface, roll-back makes it difficult for the vehicle to drive forward in the desired direction. The system according to the present invention assists the driver in such situations, and thereby preventing excessive wear on the clutch and stalling of the engine. The information supplied by a gear sensor or a transmission step (in an automatic transmission) is therefore combined with an active brake pressure build-up system. No braking intervention on the part of the driver is necessary. The driver merely operates the accelerator pedal and the clutch pedal at least to some extent. No further sensors are needed in addition to the gear sensor and/or information regarding the transmission step.

If the drive direction of the engaged gear and the direction of movement of the vehicle do not correspond when driving a vehicle up or down a hill, it is assumed that the driver would like to drive in the opposite direction, i.e., in the direction of the engaged gear. In this case, according to the present invention, the brake pressure is built up so that the vehicle speed while rolling in the direction opposite the direction intended by the driver is limited to a low value.

The present invention detects the signals of the gear sensor and then generates an active brake pressure build-up if the direction of movement of the vehicle does not match the direction of the gear. The pressure is built up so that the vehicle does not exceed a preselectable low speed. To do so, a cruise control may be used, e.g., as part of an HDC regulation (HDC=hill descent control) which regulates the brake pressure so that a low constant longitudinal vehicle speed is established. A value of 1 m/s has proven suitable in tests.

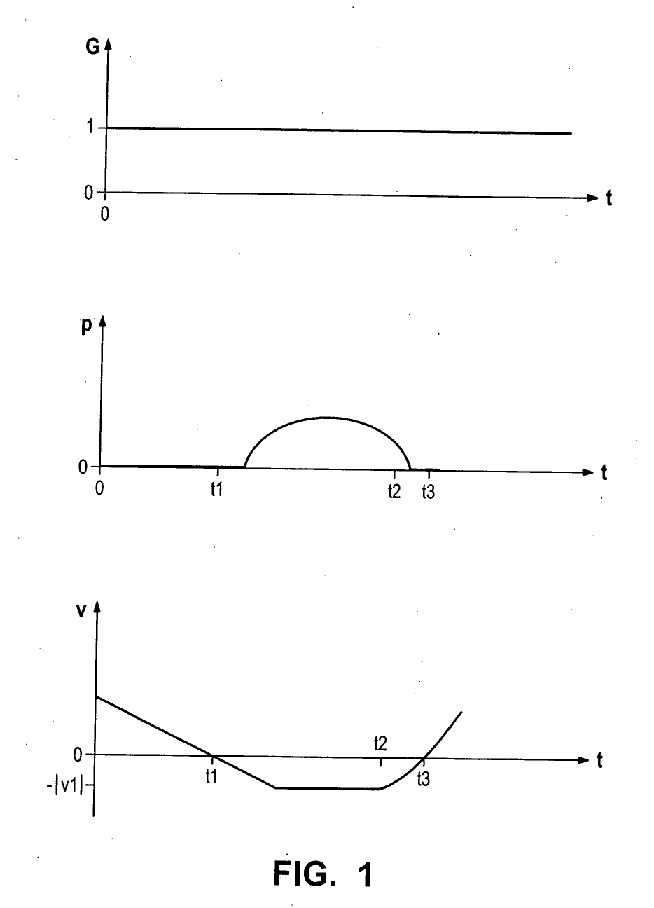

FIG. 1 shows the curves of various vehicle parameters plotted as a function of time. To do so, time t is plotted on the abscissa, and the ordinate showing:
engaged gear step G in the top diagram (G=1 in the diagram, i.e., first gear has been engaged),
in the middle diagram, brake pressure p, which may be applied to all wheels or only to the wheels of one axle, and
in the bottom diagram, longitudinal vehicle speed v.

FIG. 1 illustrates the case in which the driver operates the clutch pedal at time t=0 when the first gear is engaged and the vehicle movement is directed uphill.

As a result, the drive train is uncoupled from the driving wheels and no drive torque is transmitted to the wheels. As a result, the vehicle loses speed, reaching a speed of zero at time t1 and then begins to roll downhill in reverse. This is quite apparent in the bottom diagram in FIG. 1. Shortly after the start of the reverse movement, a brake pressure p is built up. The brake pressure is set so that the absolute value of the longitudinal vehicle speed does not exceed a value If a negative sign is assigned to the reverse movement of the vehicle as in FIG. 1, v is greater than or equal to −|v1|.

At point in time t2, the driver releases the clutch pedal again entirely or partially. As a result of this, engine torque is again transmitted to the wheels, the speed begins to increase again, reaches a value of zero at t=t3, and then becomes positive again.

Brake pressure p may then be set either only on the wheels of one axle or on all wheels of the vehicle. It is also possible for different brake pressures to be applied to the front wheels and the rear wheels.

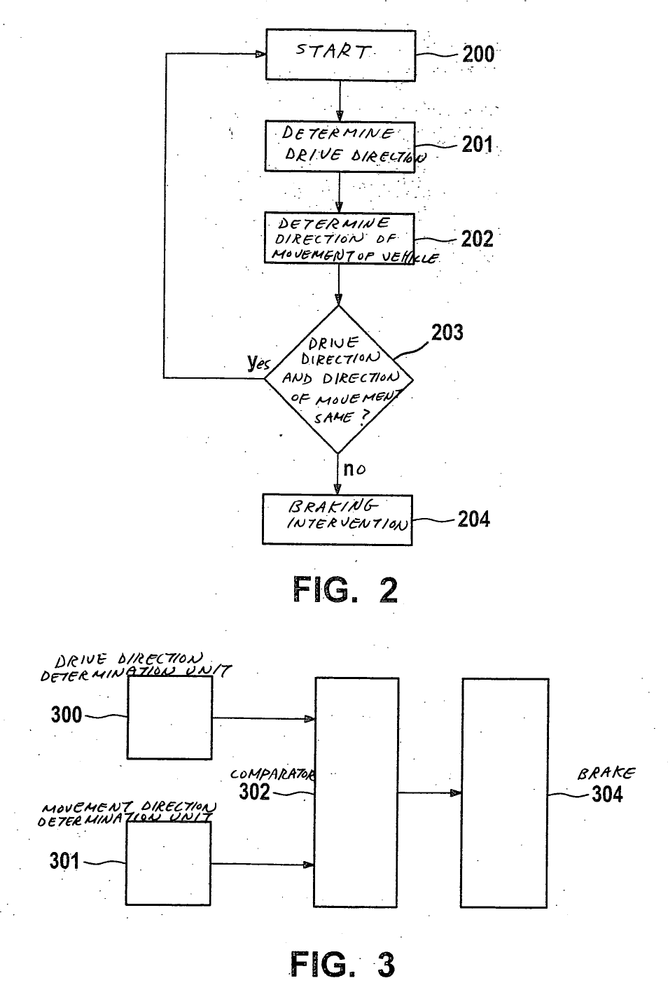

FIG. 2 illustrates the sequence of the method according to the present invention. After the start in block 200,
the drive direction of the vehicle correlating with the engaged gear step, i.e., transmission step, is determined in block 201, and
the direction of movement of the vehicle is determined in block 202.

In block 203, there is then a query to determine whether the direction of movement and the drive direction are the same. If the answer is yes, the system branches back to block 200. If the answer is no, the direction of movement is opposite the drive direction. In this case, in block 204, braking intervention measures are implemented independently of the driver on the wheels of at least one axle, so that the vehicle speed is regulated to a preselected low value.

FIG. 3 shows a block diagram of the device for limiting motor-vehicle rollback. The device includes:
drive direction determination means 300 for determining the drive direction belonging to the engaged gear step, i.e., transmission step, and
movement direction determination means 301 for determining the direction of movement of the motor vehicle.

The output signals of blocks 300 and 301 are sent to comparator means 302 for comparing the drive direction and the direction of movement. In turn, comparator means 302 control brake means 304 in the case when the direction of movement is opposite the drive direction so that braking intervention is performed independently of the driver on the wheels of at least one axle.

1-10. (canceled)

11. A method for limiting roll-back of a motor vehicle, comprising:
determining an intended drive direction of the vehicle corresponding to an engaged gear step;
determining a direction of movement of the vehicle; and
automatically performing a braking intervention at at least one wheel of at least one axle independently of the driver, if the direction of movement of the vehicle is opposite the intended drive direction of the vehicle.

12. The method as recited in claim 11, wherein the braking intervention is performed in such a way that the absolute value of the vehicle speed does not exceed a predetermined reference longitudinal vehicle speed in the direction of movement of the vehicle, wherein the predetermined reference longitudinal vehicle speed is different from zero.

13. The method as recited in claim 12, wherein the braking intervention is performed in such a way that the absolute value of the vehicle speed is regulated to the predetermined reference longitudinal vehicle speed.

14. The method as recited in claim 13, wherein the predetermined reference longitudinal vehicle speed is set as part of a hill-descent-control regulation.

15. The method as recited in claim 11, wherein initiation of the method is dependent on the accelerator pedal position.

16. The method as recited in claim 15, wherein the method is initiated when the accelerator pedal is actuated.

17. The method as recited in claim 11, wherein initiation of the method is dependent on the position of the clutch pedal.

18. The method as recited in claim 17, wherein the method is initiated when the clutch pedal is at least partially actuated.

19. A device for limiting roll-back of a motor vehicle, comprising:
a drive-direction-determination unit for determining an intended drive direction of the vehicle corresponding to an engaged gear step;
a movement-direction-determination unit for determining a direction of movement of the vehicle; and
a comparator for comparing the intended drive direction and the direction of movement; and
a brake unit operatively coupled to the comparator, wherein a braking intervention is automatically performed at at least one wheel of at least one axle independently of the driver, if the direction of movement of the vehicle is opposite the intended drive direction of the vehicle.

20. The device as recited in claim 19, wherein the movement-direction-determination unit is a wheel rpm sensor.
